(19) United States
(12) Patent Application Publication
(10) Pub. No.: US 2007/0283952 A1
(43) Pub. Date: Dec. 13, 2007

(54) Pressure sensing in masks

(76) Inventor: Mark Wilbur, Concord Township, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/519,160

(22) Filed: Sep. 11, 2006

Related U.S. Application Data
(60) Provisional application No. 60/813,292, filed on Jun. 13, 2006.

(51) Int. Cl. A62B 7/00; A62B 18/08

(52) U.S. Cl. 128/201.19; 128/200.24

(57) ABSTRACT

A method includes the steps of sensing pressure changes inside a mask of a user; and electronically controlling a function related to the mask or electronically making a determination related to the user on the basis of the sensed pressure changes. The sensor may be a solid state pressure sensor that is inside the mask and not associated with the mask regulator. The function may be microphone control stress level monitoring, mask integrity monitoring, or estimating of remaining tank air, as examples.

### RELATED APPLICATIONS

This application claims the benefit of the filing date of U.S. Provisional Application No. 60/813,292, filed Jun. 13, 2006, the entire disclosure of which is hereby incorporated by reference.

### BACKGROUND

The present application relates to sensing of pressure in masks, and also to making a determination or controlling a function in response to the pressure sensing.

Protective gas masks or face masks are well known in the art, for example, as used by firefighters. These masks provide breathing capabilities while protecting the mask user from noxious gases, smoke, paint fumes, etc. The mask provides a mask seal against the user's face. Fresh air from a compressed air source, such as a tank, is directed into the inside of the mask, through a regulator located outside the mask seal.

Users of masks often have a need to communicate with one another, particularly during emergency situations. Mask communication systems often use a microphone to pick up the user's voice. The output of the microphone is amplified and/or transmitted to make the voice able to be heard elsewhere. One problem with such a system is that the microphone picks up sounds other than the user's voice. Another problem with such a system is that the battery on such a unit can discharge faster than desired.

### BRIEF DESCRIPTION OF THE DRAWINGS

FIG. 1 is a partially schematic representation of a system that includes a mask and that is a first embodiment of the invention;

FIG. 2 is a schematic view looking out from inside the mask of FIG. 1;

FIG. 3 is a schematic representation of the system of FIG. 1;

FIG. 4 is a timeline showing a correlation between microphone control and air valve opening and closing; and

FIG. 5 is a flow diagram of one or more embodiments of the invention.

### DESCRIPTION

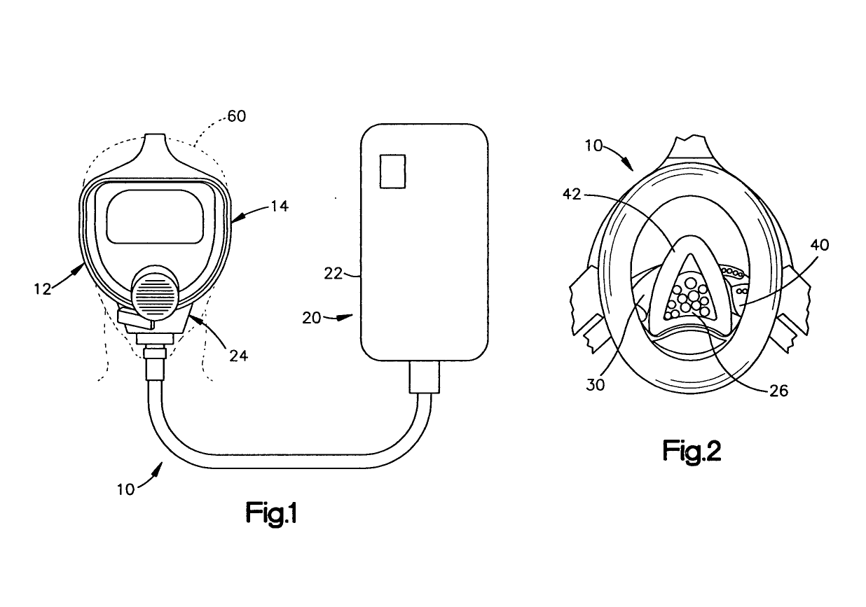

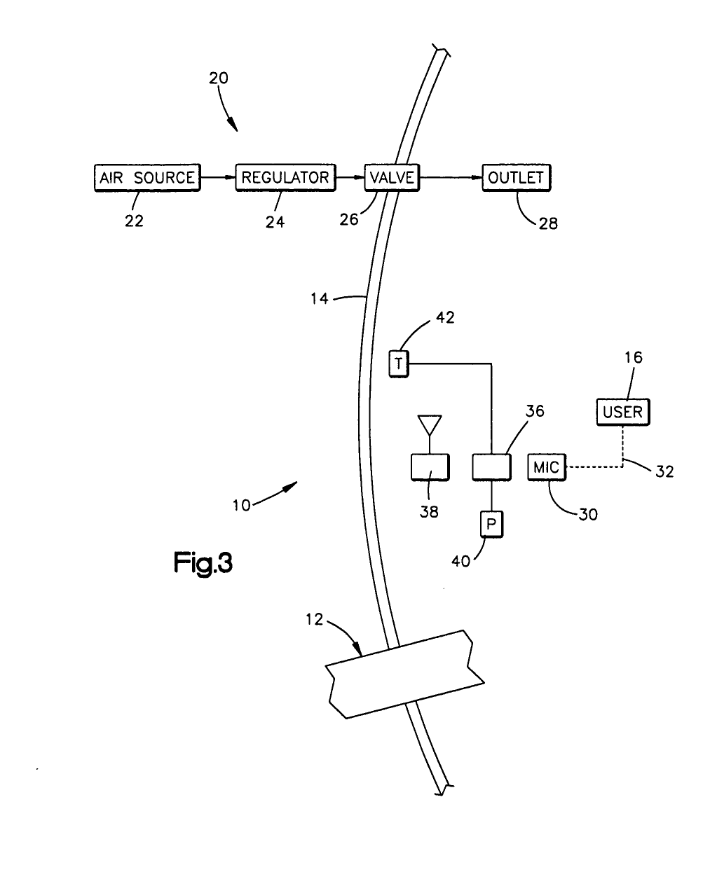

As representative only of the invention, FIGS. 1-3 illustrate schematically a system 10 that includes a mask 12. The mask 12 may be a firefighter's mask, as one example. The mask 12 has a mask seal 14, which is a portion of the mask that seals against the user's head or face, to seal out atmospheric contaminants such as smoke. The term “mask seal” may also be used herein to indicate the intangible “seal” that is provided by the mask 12. The mouth and nose of the user 16 are located inside the mask 12—that is, within the mask seal 14, as opposed to outside the seal.

The mask 12 is typically provided with a compressed air supply 20. The air supply 20 includes a compressed air source 22, which may be a tank, located outside the mask 12 (that is, outside the mask seal 14). The output of the air source 22 flows through a regulator 24 outside the mask 12, which lowers the pressure of the compressed air to at or near atmospheric pressure. The air from the regulator 24 then flows through a valve 26. The valve 26 may form part of the mask seal 14. The valve 26 is opened and closed, in a known manner in response to the user's breathing, to control the flow of air through an outlet 28 that is located inside the mask.

A microphone 30 is mounted inside the mask 12, in a manner not shown. If the microphone 30 is not located directly in front of the mouth of the user 16, the mask may include a voice tube 32 that directs sound (speech) from the user 16 into the microphone 30 at a location remote from the user's mouth.

Electric circuitry indicated schematically at 36 is located on the mask 12, preferably but not necessarily inside the mask seal 14. The circuitry 36 may be (or include) a microprocessor, for example. The output of the microphone 30 is operatively connected to the circuitry 36.

A transceiver 38 is located on the mask 12, preferably but not necessarily inside the mask seal 14. The transceiver 38 is electrically connected with the circuitry 36. The transceiver 38 is operative to transmit the output of the microphone 30 to a location outside the mask 12, without breaking the mask seal 14.

A pressure sensor 40 is located inside the mask 12, within the mask seal 14. In one embodiment, the pressure sensor 40 is a solid state pressure sensor. Suitable commercially available devices include, as examples, the Freescale Semiconductor brand MPXV7002 series integrated pressure sensor, and the Honeywell brand XCAL4004GN pressure sensor. Such devices may have dimensions in the range of, for example, one half inch by one half inch. Desirable characteristics of the pressure sensor 40 are small size, low power consumption, and ability to withstand harsh environments. The output of the pressure sensor 40 is operatively directed to the circuitry 36.

An optional ambient temperature sensor 42 is located on the mask 12, possibly inside the mask seal 14 although alternatively on the tank, etc. The output of the temperature sensor 42 is operatively directed to the circuitry 36.

The circuitry 36 is operative to determine changes in pressure inside the mask 12, on the basis of the output of the pressure sensor 40. The mask 12 is of the type that maintains a positive pressure (greater than ambient) inside the mask. This pressure is provided by the compressed air supply 20, which periodically provides clean compressed air into the mask 12. This enables the user 16 to breathe clean compressed air and not ambient air which may be contaminated in, for example, a fire fighting environment. The compressed air is provided by opening and closing of the valve 26.

When the valve 26 is being opened and closed, it makes an amount of noise that can be significant as compared to, for example, a user's voice. In addition, the noise made by the inrushing compressed air being delivered into the interior of the mask 12 through the valve 26, when the valve is open, can also be significant as compared to a user's voice.

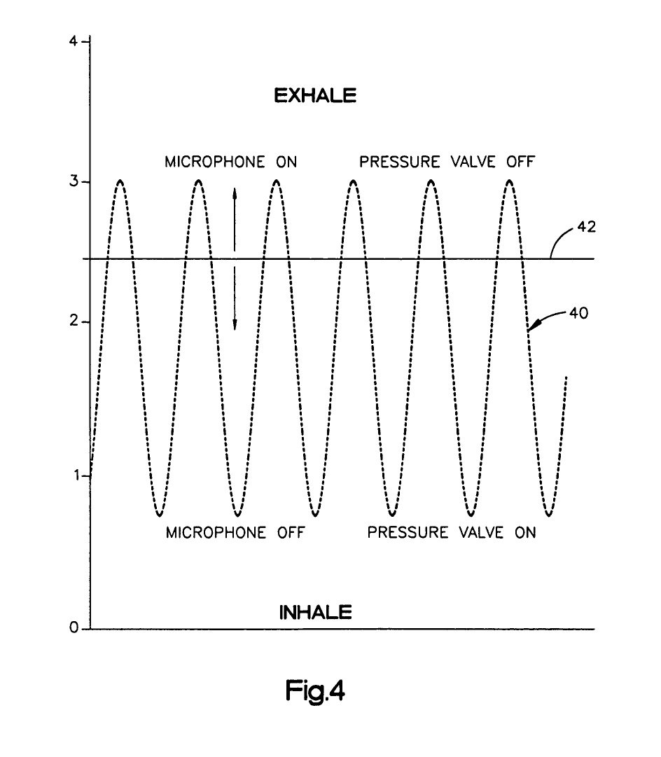

In accordance with one aspect of the present invention, the microphone 30 is turned on and off in synchronism with the opening and closing of the valve 26. This relationship is illustrated schematically in FIG. 4, which is a timeline showing pressure inside the mask 10, as measured by the sensor 30 and indicated by the curve 50, on the vertical axis. Time is plotted on the horizontal axis. A rising curve 50 (to the right) indicates an increase in pressure, as when the user is exhaling or speaking. A falling curve 50 indicates a decrease in pressure, as when the user inhales.

The horizontal line 52 indicates generally the point at which the valve 26 of the compressed air supply 20 opens and closes. The valve 26 is open when the pressure curve 50 is below the line 52. The valve 26 is closed when the pressure curve 50 is above the line 52.

The output of the pressure sensor 40 is used as an input to the circuitry 36 to control the on/off state of the microphone 30. Specifically, the output of the pressure sensor 40 is used to help determine the pressure, and pressure changes, inside the mask 12. The circuitry 36 is calibrated to turn the microphone 30 off when the value of the pressure inside the mask 12, as sensed by the sensor 40, is determined to be indicative of the valve 26 being opened. The circuitry 36 is calibrated to, thereafter, turn the microphone 30 back on when the value of the pressure inside the mask 12, as sensed by the sensor 40, is determined to be indicative of the valve 26 thereafter having been closed.

As a result, the microphone 30 is off when the valve 26 is being opened. Therefore, the sound made by the valve 26 when it is opening is not transmitted by the microphone 30. In addition, the microphone 30 is off when the valve 26 is being closed. Therefore, the sound made by the valve 26 when it is closing is not transmitted by the microphone 30. In addition, the microphone 30 is off during the time period in which the valve 26 is open and compressed air is being admitted to the mask 12. Therefore, the sound of the inrushing compressed air is not transmitted by the microphone 30. At other times, the microphone 30 may be left on so that the user's voice can be heard.

A benefit of the microphone 30 being turned off during these time periods is that the sound of the valve 26 opening and closing, and the sound of the inrushing compressed air, is not broadcast to others around the user. Such a broadcast can be distracting, as it is desired to hear only the user's voice, not these additional sounds.

Another benefit of the microphone 30 being turned off during these time periods is that the battery that powers the electronic components, such as the microphone and transceiver, attains a longer life. When the microphone 30 is off, no sound is being transmitted, and so battery usage is reduced.

Alternatively, or in addition, the circuitry 36 can be calibrated to have the microphone 30 on at additional times, as desired, to enable the user's voice to be heard more continuously. For example, the circuitry 36 can be designed to sense rising and falling pressure and in response determine opening and closing times for the microphone 30, at a time separate from the actual opening and closing of the valve 26.

Because the pressure sensor 40 is located inside the mask seal 14, it is not associated with or a part of the regulator 24. Therefore, the regulator 24 does not need to be modified to accommodate the pressure sensor 40. It is quite expensive to modify a regulator to accept a new pressure sensor, while it is comparatively inexpensive to add a pressure sensor inside the mask 12. This enables users to continue using existing regulators and masks, while retrofitting with the pressure sensor capability. Also, it enables mask manufacturers to add the pressure sensor capability while using their existing regulators and masks. A pressure sensor 40 inside the mask can work with any regulator and need not be designed to work with or fit a particular regulator.

Use of the pressure sensor 40 for microphone control is one example of electronically controlling a function related to the mask 12, or electronically making a determination related to the mask or to the user. The pressure sensor 30 can be used for purposes other than microphone control, thus electronically controlling a different function related to the mask or electronically making a different determination related to the mask or to the user.

As one example, the pressure sensor 40 can be used to provide a status or warning of mask pressure. The output of the pressure sensor 40, as read by the circuitry 36, can be transmitted to the user 16 in a visual or audible display. Thus, the user 16 can be notified if, for example, the internal pressure drops below a certain level or below outside pressure as may happen if, for example, the mask seal 14 is compromised. The pressure inside the mask 12 is correlated with the level of integrity of the mask seal 14. This is accomplished without breaking the mask seal 14 because the sensor 40 and associated circuitry 36 are located inside the mask 12. This data as to the integrity of the mask seal 14 can also be transmitted to a location outside the mask 12.

As another example, the pressure sensor 40 can be used to monitor user stress level. The user's breathing pattern, as determined on the basis of pressure fluctuations inside the mask 12, and including frequency, for example, is correlated with the level of stress on the user 16. The determination of the stress level can be employed to help assist the user 16, if needed. As another example, if the breathing pattern becomes very shallow, it might be determined that the user 16 is unconscious.

As yet another example, the pressure sensor 40 can be used to predict tank capacity (remaining air in the tank 22). Thus, over time a user's breathing pattern can be monitored (counting the number of breaths, for example), to help estimate how fast the air in the tank 22 is being used up. This could help when notifying the user 16 of the amount of air left in the tank 22. Such monitoring could be even more useful in conjunction with the output of the ambient temperature sensor 42. The pressure in the tank 22 is proportional to ambient temperature, and the pressure varies when the firefighter goes from cold to hot and back—without any change the quantity of remaining air. Thus, a tank pressure reading alone is not necessarily representative of remaining tank volume. Correlating breathing patterns and ambient temperature readings can provide a more accurate determination.

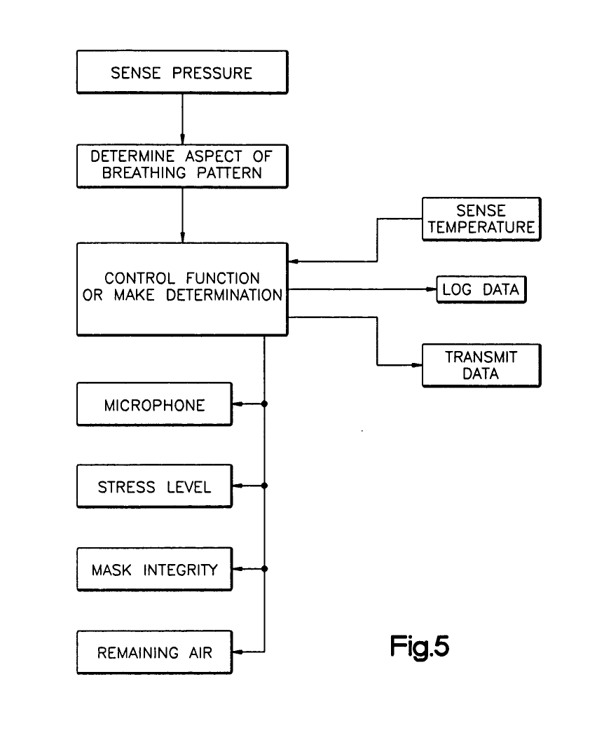

FIG. 5 is a flow chart showing the operation of one or more methods that may be embodiments of the invention. Pressure is sensed using the pressure sensor 40, and an aspect of the user's breathing pattern is determined, for example time of inhalation and exhalation. On the basis of the determination, and possibly with the aid of sensed temperature, a function related to the mask is controlled or a determination related to the user is made on the basis of the sensed pressure changes. That function or determination can include microphone control, stress level monitoring, mask integrity monitoring, and remaining air estimating. As noted in FIG. 5, data relating to the user as determined on the basis of pressure sensing can be transmitted to the user or out of the mask, and the data can be logged also.

We claim:

1. A method comprising the steps of:
sensing pressure changes inside a mask of a user;
electronically controlling a function related to the mask or electronically making a determination related to the user on the basis of the sensed pressure changes.

2. A method as set forth in claim 1 further comprising the step of directing compressed air from a compressed air source located outside the mask through a regulator located outside the mask and through a valve to a location inside the mask.

3. A method as set forth in claim 1 wherein the step of controlling a function comprises:
controlling the on/off state of a microphone associated with the mask.

4. A method as set forth in claim 1 wherein the step of controlling the on/off state of a microphone associated with the mask comprises:
turning the microphone off at or near the beginning of the inhalation portion of the user's breathing cycle and turning the microphone on at or near the end of the inhalation portion of the user's breathing cycle.

5. A method as set forth in claim 1 wherein the step of sensing pressure changes is performed with a solid state pressure sensor.

6. A method as set forth in claim 1 wherein the step of controlling a function comprises monitoring the stress level of the user of the mask.

7. A method as set forth in claim 1 wherein the step of controlling a function comprises monitoring the integrity of the mask seal of the mask.

8. A method as set forth in claim 1 wherein the step of controlling a function comprises predicting remaining tank capacity.

9. A method as set forth in claim 8 further comprising the steps of sensing ambient temperature and using the sensed temperature in predicting the remaining tank capacity.

10. Apparatus comprising:
a mask having a mask seal for sealing against the face of a user;
a pressure sensor inside the mask for sensing pressure variations inside the mask
a microphone inside the mask for picking up the voice of a user of the mask;
electric circuitry on the mask and operatively connected with the output of the pressure sensor and with the output of the microphone; and
a transmitter on the mask and operatively connected with the electric circuitry for transmitting data from the microphone and to a location outside the mask.

11. Apparatus as set forth in claim 10 wherein the transmitter is operative also to transmit data from the pressure sensor to a location outside the mask.

12. Apparatus as set forth in claim 10 wherein the pressure sensor is a solid state pressure sensor.

13. Apparatus as set forth in claim 10 further comprising a compressed air source with a regulator located outside the mask, and a valve that is opened and closed for controlling flow of air from the regulator to the inside of the mask;
and wherein the electric circuitry is operative to control an on/off state of the microphone and to correlate the on/off state of the microphone with the open/closed state of the valve.

14. Apparatus as set forth in claim 10 further comprising means for electronically controlling a function related to the mask or electronically making a determination related to the user on the basis of the sensed pressure changes.

15. Apparatus as set forth in claim 14 wherein the means comprises means for controlling the on/off state of the microphone.

16. Apparatus as set forth in claim 14 wherein the means comprises means for estimating remaining tank capacity of the user.

17. Apparatus as set forth in claim 14 wherein the means comprises means for monitoring the stress level of the user.

18. Apparatus as set forth in claim 14 wherein the means comprises means for monitoring the integrity of the mask seal.

19. Apparatus comprising:
a mask having a mask seal for sealing against the face of a user;
a pressure sensor inside the mask for sensing pressure changes inside the mask; and
means for electronically controlling a function related to the mask or electronically making a determination related to the user on the basis of the sensed pressure changes.

20. Apparatus as set forth in claim 19 wherein the means comprises means for controlling the on/off state of a microphone of the mask.

21. Apparatus as set forth in claim 19 wherein the means comprises means for estimating remaining tank capacity of a compressed air tank of the user.

22. Apparatus as set forth in claim 19 wherein the means comprises means for monitoring the stress level of the user.

23. Apparatus as set forth in claim 19 wherein the means comprises means for monitoring the integrity of the mask seal.
